(19) United States
(12) Patent Application Publication
(10) Pub. No.: US 2002/0098861 A1
(43) Pub. Date: Jul. 25, 2002

(54) Method and system for preventing wireless devices from interfering with other equipment in a sensitive area

(75) Inventors: Richard Michael Doney, Durham, NC (US); Peter J. Kennedy, Durham, NC (US)

Correspondence Address: Joseph A. Sawyer, Jr., Sawyer Law Group, LLP, P.O. Box 51418, Palo Alto, CA, 94303, US

(73) Assignee: International Business Machines Corporation, Armonk, NY

(21) Appl. No.: 09/766,265

(22) Filed: Jan. 19, 2001

(51) Int. Cl. H04B 7/00

(52) U.S. Cl. 455/527; 455/419; 455/414

(57) ABSTRACT

A method and system for preventing a wireless device from interfering with equipment within a sensitive area is disclosed. The method comprises transmitting a radio signal from the sensitive area to the wireless device; receiving the radio signal by the wireless device; and then deactivating at least one portion of the wireless device based upon receiving the radio signal. A system and method in accordance with the present invention allows for the automatic deactivation of a portion of a wireless device that is disruptive to the sensitive area. For example, if the user is utilizing a laptop computer which emits radiation that might interfere with successful operations of an airplane, those portions of the laptop that emit radiation that is disruptive would be turned off automatically but other functions of the laptop computer would still be available to the user.

### FIELD OF THE INVENTION

The present invention relates to wireless devices and more particularly to the silencing of wireless devices in sensitive areas.

### BACKGROUND OF THE INVENTION

Wireless devices are utilized extensively. Wireless devices include but are not limited to laptop computers, cellular phones, personal digital assistants and the like. Currently, when transmission or reception by or from a wireless device will interfere with equipment located in a sensitive area, the wireless device must be turned off manually. For example, on airplanes typically all devices that might interfere with its successful operation must be turned of. These types of devices typically emit radio signals within certain frequency ranges. For example, one function a laptop computer can have operates in accordance with the IEEE standard 802.11 which provides for certain portions of the computer to emit radio signals within certain frequency ranges. These radio signals might interfere with the operation of the airplane and communications between the airplane and the air traffic control system. Accordingly, the laptop must be turned off before the plane takes off or lands.

When the user is requested to turn off a wireless device, in this case a laptop in a sensitive area, the user may decide not to turn it off or might forget to turn it off, thereby interfering with the equipment, in this case the airplane, in the sensitive area.

Also, if the user turns off the device, this will cause the entire device to be turned off. However, only a portion of the device may be disruptive. Another portion of the device may not be disruptive. If this device were a laptop computer, for example, turning off the entire device would present an inconvenience to the user, since the user could no longer utilize the laptop computer. Accordingly, what is needed is a system and method for automated silencing of wireless devices in sensitive areas. The present invention addresses such a need.

### SUMMARY OF THE INVENTION

A method and system for preventing a wireless device from interfering with equipment within a sensitive area is disclosed. The method comprises transmitting a radio signal from the sensitive area to the wireless device; receiving the radio signal by the wireless device; and then deactivating at least one portion of the wireless device based upon receiving the radio signal.

A system and method in accordance with the present invention allows for the automatic deactivation of a portion of a wireless device that is disruptive to the sensitive area. For example, if the user is utilizing a laptop computer which emits radiation that might interfere with successful operations of an airplane, those portions of the laptop that emit radiation that is disruptive would be turned off automatically but other functions of the laptop computer would still be available to the user.

The method in accordance with the present invention can be utilized with any wireless device which might interfere with equipment in a sensitive area, as, for example, portable wireless computers such as cellular phones and the like.

Currently, offending wireless equipment must be turned off manually. The present invention automates the switching off and on function and does not require the user to take any overt action to comply with existing rules. A system and method in accordance with the present invention is user friendly, and it prevents users from deliberately activating devices in a sensitive area.

### BRIEF DESCRIPTION OF THE DRAWINGS

FIG. 1 illustrates a simple block diagram of a system in accordance with the present invention.

FIG. 2 illustrates the system in accordance with the present invention in greater detail.

FIG. 3 is a flow chart which illustrates the process of the present invention.

### DETAILED DESCRIPTION

The present invention relates to wireless devices and more particularly to the silencing of wireless devices in sensitive areas. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

As wireless devices become widespread, they may enter into areas where their transmissions and receptions may be disruptive to the operation of the area. An example of this could be a laptop computer with IEEE standard 802.11 transmissions and receptions being used on an aircraft. The transmissions and receptions of 802.11 could interfere with the plane's navigational devices. In this case the laptop and other similar wireless devices which interfere must be manually turned off. Many such areas exist where radio silence is mandated for safety reasons, including munitions or fuel depots, aircraft fueling operations areas and aircraft in flight.

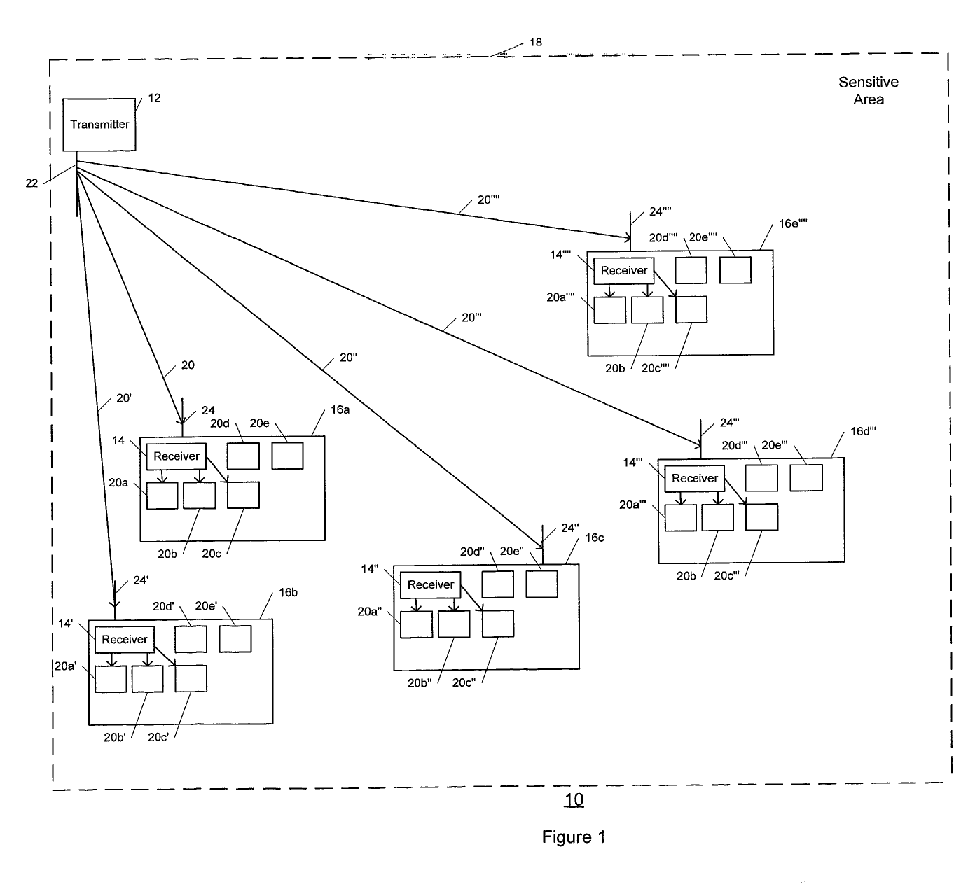

FIG. 1 illustrates a simple block diagram of a system 10 in accordance with the present invention. The system 10 includes a transmitter 12 in a facility and a plurality of wireless devices 16a-16e. Each of the plurality of wireless devices 16 includes a receiver mechanism 14 for receiving signals from the transmitter in the facility 18. As is seen, each of the wireless devices 16a-16e includes a plurality of functions 20a-20d, 20a′-20d′, 20a″-20d″, 20a′″-20d′″ and 20a′″-20d′″, respectively. As is also seen the functions 20a, 20b and 20c are coupled to the receiver mechanism and the functions 20d and 20e are not coupled to the receiver mechanism 14. The receiver mechanism 14 will then deactivate the functions 20a-20c when the device is within a sensitive area. On the other hand, in a preferred embodiment the functions 20d and 20e can continue to function since the receiver mechanism will not deactivate those portions. One of ordinary skill in the art readily recognizes, however, that the receiver mechanism could disable the entire device and that use would be within the spirit and scope of the present invention. As is seen, each of the wireless devices 16a-16f have different functions which are coupled and not coupled to their respective mechanism. The transmitter 12 in the sensitive area 18 transmits a radio signal 20 directed towards the plurality of offending wireless devices 16 located in the sensitive area 18. The radio signal 20 includes commands to the receiver mechanism 14 to deactivate the appropriate portions of the wireless devices. The receiver mechanism 14 then deactivates the appropriate portions of the wireless device.

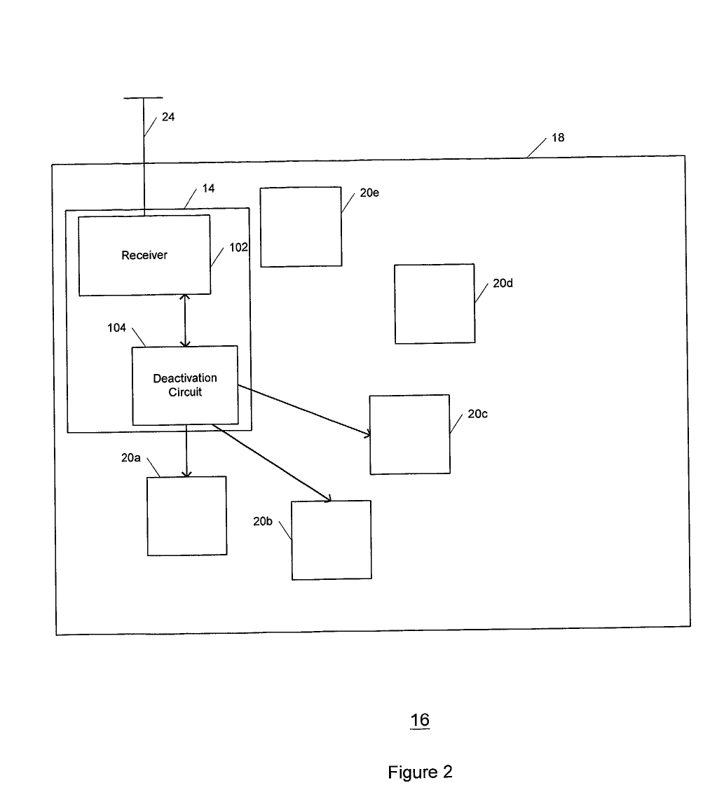

FIG. 2 illustrates one of the plurality of wireless devices 16a-16e of the present invention in greater detail. The wireless device 16 is equipped with a receiving antenna 24 and receiver mechanism 14. The wireless device 16 includes a receiver mechanism 14, which instructs circuitry within the wireless device 16 to shut down all functions of the wireless device 16 that interfere with sensitive equipment in the sensitive area 18. The receiver mechanism 14 includes a receiver 102 for receiving the radio signal from a transmitter and a deactivating circuit 104 coupled to the receiver 102 and the appropriate offending portions 20a20d. A radio signal 20 from the transmitter 12 can be sent, so that if a user turned the function back on while in the sensitive area 18, the wireless device 16 would automatically be switched off and would remain switched off during the entire time that the user was in the sensitive area 18. The radio signal 20 in a preferred embodiment is a continuous signal. However, the radio signal could be periodic in nature, activated by the entrance of a wireless device to the sensitive area or be provided in some other manner and its use would be within the spirit and scope of the present invention. To more particularly explain the operation of the system 10 refer now to the following description with the accompanying figures.

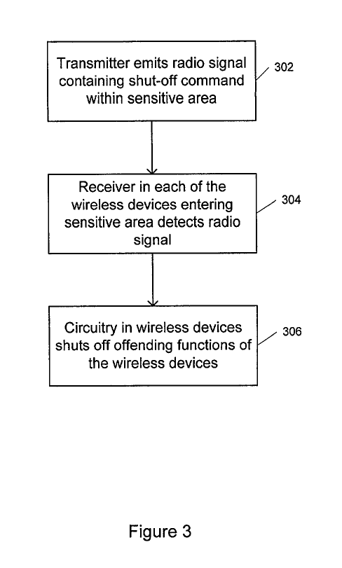

FIG. 3 is a flow chart which illustrates the process in accordance with the present invention. Referring now to FIGS. 1, 2 and 3 together, a transmitter 12 sends out a radio signal 20 through a transmitting antenna 22 located in the sensitive area 18, via step 302. The radio signal preferably would include a command indicating that the appropriate functions in wireless devices or the entire wireless device is to be deactivated in the area. When a wireless device or devices 16 enters the sensitive area 18, the radio signal 20 is detected, via step 304. Finally, when circuitry in the wireless device or devices 16 detects a signal from the transmitter antenna 22, it will activate a deactivation circuit 104 in the wireless device or devices 16 to deactivate the functions of the device or devices 16 which could interfere with equipment in the sensitive area 18, via step 306.

A system and method in accordance with the present invention enables automatic switching off of offending functions of a plurality of wireless devices when the devices are within a sensitive area with no manual intervention. Additionally, users are prevented from either inadvertently or maliciously turning back on offending devices, thereby causing either navigational problems, in the case of the airplane, or other potential problems in areas of sensitive equipment.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in lo the art without departing from the spirit and scope of the appended claims.

What is claimed is:

1. A method for preventing a wireless device from interfering with equipment in a sensitive area, the wireless device including at least one function which can disrupt the equipment in the sensitive area, comprising the steps of:
(a) transmitting a radio signal to the wireless device;
(b) receiving the radio signal by the wireless device; and
(c) deactivating the at least one function of the wireless device based upon receiving the radio signal.

2. The method of claim 1 wherein the radio signal is transmitted continuously.

3. The method of claim 1 wherein the radio signal is transmitted periodically.

4. The method of claim 1 wherein the radio signal includes a command to deactivate the at least one function.

5. The method of claim 1 wherein the radio signal deactivates the wireless device.

6. A wireless device comprising:
a plurality of functions; and
a receiver mechanism coupled to at least one of the plurality of functions, the receiver mechanism for deactivating the at least one of the plurality of functions if a radio signal is received which indicates that the at least one function should be deactivated.

7. The device of claim 6 wherein the radio signal is transmitted continuously.

8. The device of claim 6 wherein the radio signal is transmitted periodically.

9. The device of claim 6 wherein the radio signal includes a command to activate the at least one function.

10. A system for preventing a wireless device from interfering with equipment in a sensitive area; the system comprising:
a transmitter for providing a radio signal; and
a receiver mechanism within the wireless device for deactivating at least one function within the wireless device when the radio signal is received by a wireless device.

11. The system of claim 10 wherein the radio signal is transmitted continuously.

12. The system of claim 10 wherein the radio signal is transmitted periodically.

13. The system of claim 10 wherein the radio signal includes a command to deactivate the at least one function.

14. The system of claim 10 wherein the receiver mechanism comprises:
a receiver circuit; and
a deactivation circuit coupled to the receiver circuit and the at least one function.
